(19) United States
(12) Patent Application Publication
(10) Pub. No.: US 2025/0212282 A1
(43) Pub. Date: Jun. 26, 2025

(54) SELECTING AMBIENT INTERNET OF THINGS (AIOT) DEVICES USING ASSISTANCE INFORMATION

(71) Applicant: Lenovo (United States) Inc., Morrisville, NC (US)

(72) Inventors: Hyung-Nam CHOI, Ottobrunn (DE); Genadi VELEV, Darmstadt (DE); Karthikeyan GANESAN, Nauheim (DE); Andreas KUNZ, Ladenburg (DE)

(21) Appl. No.: 19/073,710

(22) Filed: Mar. 7, 2025

(51) Int. Cl. H04W 76/18; H04W 4/38; H04W 28/06

(52) U.S. Cl. CPC H04W 76/18; H04W 28/06; H04W 4/38

(57) ABSTRACT

Various aspects of the present disclosure relate to a radio access network (RAN) node and/or associated network function to adapt the size of an ID filter mask based on limitations of an ambient Internet of Things (AIoT) radio interface at the time of a requested AIoT operation (e.g., an inventory procedure). For example, the RAN node may receive an ID filter mask within a request message, transmit assistance information back to a requesting function that includes an indication of an allowable size for the ID filter mask, and receive an updated, modified, or new ID filter mask having an allowable size for the AIoT radio interface.

### TECHNICAL FIELD

The present disclosure relates to wireless communications, and more specifically to the selection of ambient Internet of Things (AIoT) devices using assistance information.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

Ambient power-enabled devices, such as AIoT devices, include battery-less devices that have limited storage capabilities (e.g., store a limited amount of energy using capacitors) or other capability restrictions. These ambient power-enabled devices may store energy by harvesting energy from the environment of the devices, such as via radio waves, light, heat, motion, and other energy/power sources available to the devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that select AIoT devices for AIoT operations using assistance information. For example, a radio access network (RAN) node may receive a request to trigger an AIoT operation, and when the request includes a filter mask associated with selecting AIoT devices for the AIoT operation, the RAN node may transmit a failure message back to a requesting network function based on the filter mask being too large for transmissions performed during the AIoT operation.

A RAN node for wireless communication is described. The RAN node may be configured to, capable of, or operable to perform one or more operations as described herein. For example, the RAN node may comprise at least one memory and at least one processor coupled with the at least one memory and configured to cause the RAN node to receive, from a network function, a first message that includes a request for triggering an ambient AIoT operation and an identifier (ID) filter mask associated with selecting AIoT devices, and transmit, to the network function, a second message that includes failure information based on the ID filter mask.

A method performed or performable by the RAN node is described. The method may comprise receiving, from a network function, a first message that includes a request for triggering an ambient AIoT operation and an ID filter mask associated with selecting AIoT devices, and transmitting, to the network function, a second message that includes failure information based on the ID filter mask.

In some implementations of the RAN node and method described herein, the failure information is based on a determination that a size of the ID filter mask is outside of a threshold size for inclusion within a reader to device (R2D) message.

In some implementations of the RAN node and method described herein, the failure information includes a reason for a failure to trigger the AIoT operation, and a requested size of the ID filter mask.

In some implementations of the RAN node and method described herein, the RAN node and method may further be configured to, capable of, performed, performable, or operable to receive a third message from the network function that includes an ID filter mask having a size that satisfies a threshold size for inclusion within a R2D message and transmit the R2D message to trigger the AIoT operation using the ID filter mask received via the third message.

In some implementations of the RAN node and method described herein, the RAN node includes a base station and a coverage area of the base station supports wireless communication for the AIoT devices.

In some implementations of the RAN node and method described herein, the RAN node includes a UE configured to operate as a reader device for the AIoT devices.

In some implementations of the RAN node and method described herein, the AIoT operation is a command procedure or an inventory procedure associated with the AIoT devices.

A network function for wireless communication is described. The network function may be configured to, capable of, or operable to perform one or more operations as described herein. For example, the network function may comprise at least one memory and at least one processor coupled with the at least one memory and configured to cause the network function to transmit, to a RAN node, a first message that includes a request for triggering an AIoT operation and an ID filter mask associated with selecting AIoT devices and receive, from the RAN node, a second message that includes failure information based on the ID filter mask.

A method performed or performable by the network function is described. The method may comprise transmitting, to a RAN node, a first message that includes a request for triggering an AIoT operation and an ID filter mask associated with selecting AIoT devices and receiving, from the RAN node, a second message that includes failure information based on the ID filter mask.

In some implementations of the network function and method described herein, the network function and method may further be configured to, capable of, performed, performable, or operable to transmit, in response to the failure information, a third message to the RAN node that includes an ID filter mask having a size that satisfies a threshold size for inclusion within an R2D message.

In some implementations of the network function and method described herein, the failure information includes a reason for a failure to trigger the AIoT operation and a requested size of the ID filter mask.

In some implementations of the network function and method described herein, the ID filter mask has a size that is based on the size of the ID filter mask.

In some implementations of the network function and method described herein, the network function is an application function (AF) of a core network (CN).

In some implementations of the network function and method described herein, the network function is an AIoT function (AIOTF) associated with management of the AIoT operation.

In some implementations of the network function and method described herein, the ID filter mask includes a mask comparison starting bit, a length of the ID filter mask, and a mask value.

### BRIEF DESCRIPTION OF THE DRAWINGS

FIG. 1 illustrates an example of a wireless communications system in accordance with aspects of the present disclosure.

FIGS. 2A-2B illustrate example topologies for AIoT devices in accordance with aspects of the present disclosure.

FIG. 3 illustrates an example deployment scenario for a reader device and associated AIoT devices in accordance with aspects of the present disclosure.

FIG. 4 illustrates a messaging flow for performing an AIoT operation in accordance with aspects of the present disclosure.

FIG. 5 illustrates another messaging flow for performing an AIoT operation in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a RAN node in accordance with aspects of the present disclosure.

FIG. 10 illustrates a flowchart of a method performed by an NE in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost and maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device).

The AIoT device may perform one or more operations (e.g., transmission, reception, via backscattering) using the stored harvested energy. For example, the AIoT device may be a passive RFID tag equipped on an object or other device enabling for tracking of a location of the object or the other device using stored harvested energy. Example use cases or AIoT operations performed by AIoT devices include inventory taking and command procedures (e.g., read, write, control, enable, disable, and so on), sensor data collection, asset tracking, actuator control, and so on.

A RAN node, such as a UE or a base station (or other NEs), may operate as a reader device that interacts with one or more AIoT devices. For example, the RAN node, as the reader device, may transmit a carrier wave to an AIoT device to excite the AIoT device to perform backscattering transmissions or other communications, may message an AIoT device during device selection procedures, or may simply read or receive the backscattering transmissions. The RAN node may interact with various network functions, such as an AIoT function (AIOTF) that communicates directly with the RAN node and/or an application function (AF) which communicates with the RAN node via the AIOTF.

The RAN node may communicate with one or more AIoT devices using specific messaging, such as device to reader (D2R) messages (e.g., messages from the AIoT device to the RAN node) and reader to device (R2D) messages (e.g., messages from the RAN node to the AIoT device). Given the limited capabilities of the AIoT devices, the D2R and R2D messages, sent over an AIoT radio interface, may be limited in size (e.g., limited to 1000 bits or fewer). During an AIoT operation, a RAN node may send messages targeted to specific or selected AIoT devices, which may be identified via unique permanent AIoT device identifiers (IDs), such as device IDs assigned to the AIoT devices via an operator, a third party, and so on. For example, the RAN node may send an R2D message, containing device IDs, to trigger an AIoT operation to a selected set of AIoT devices. However, given the limited size of the R2D message, the device IDs may have a size that is too large to be contained in R2D messages.

The RAN node may employ an ID filter mask to reduce the size of the identifier used when selecting the AIoT devices for the AIoT operation. An ID filter mask, in some cases, includes a starting bit for a mask comparison (e.g., a comparison with each device ID), a length of the mask, and a mask value. The RAN node may then transmit the R2D message, containing the ID filter mask to all available or local AIoT devices. The AIoT devices, receiving the R2D message, determine whether their device ID matches the ID filter mask. When there is a match, the matching AIoT device is selected for the AIoT operation.

Problems may arise when using an ID filter mask to identify and/or select AIoT devices for AIoT operations. For example, the size of the R2D message may be variable and based on a size or target coverage of a service area (e.g., an area served by the RAN node). An AIoT radio interface, therefore, may be limited based on repetitions needed to meet a target coverage, limited energy availability in associated AIoT devices (e.g., due to their capacitor sizes), and so on. Thus, some R2D messages may have actual maximum sizes that are too low (e.g., 400 bits or lower) to accommodate the size of an ID filter mask.

To overcome such issues, the technology described herein enables a RAN node and/or associated network function (e.g., an AIOTF or AF) to adapt the size of an ID filter mask based on limitations of an AIoT radio interface at the time of a requested AIoT operation (e.g., an inventory procedure). For example, the RAN node may receive an ID filter mask within a request message, transmit assistance information back to a requesting function that includes an indication of an allowable size for the ID filter mask, and receive an updated, modified, or new ID filter mask having an allowable size for the AIoT radio interface. In doing so, a RAN node or network function can efficiently adapt ID filter masks based on limitations associated with an AIoT radio interface, avoiding the use of message segmentation and other procedures that may introduce complexity for the AIoT devices, among other benefits.

Aspects of the present disclosure are described in the context of a wireless communications system.

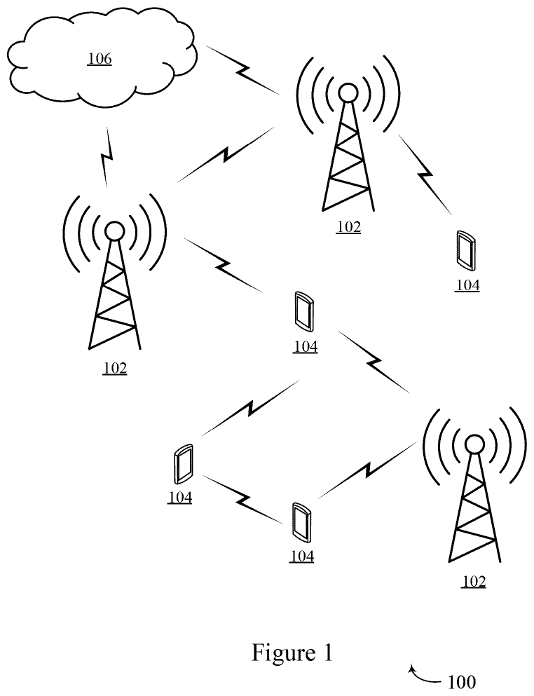

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

In some embodiments, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

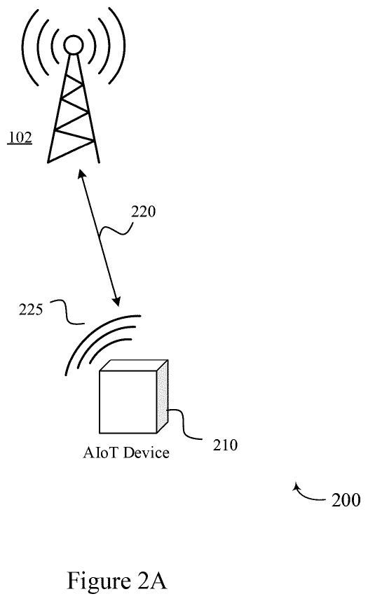

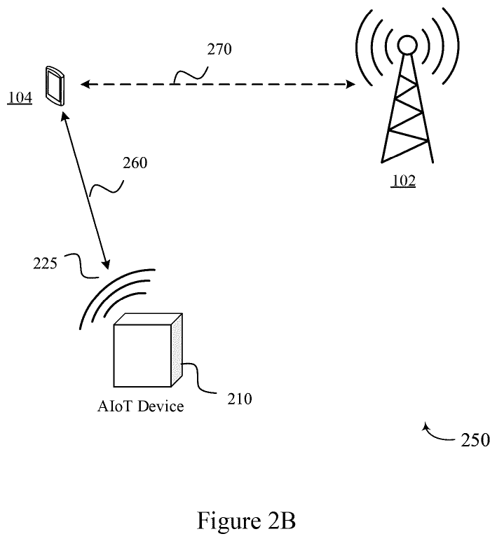

FIGS. 2A-2B illustrate example topologies for AIoT devices in accordance with aspects of the present disclosure. As shown in FIG. 2A, in a first topology 200, an AIoT device 210 directly and bidirectionally communicates with the NE 102 (e.g., which may serve a micro cell). A communication link 220 between the NE 102 and the AIoT device 210 may include AIoT data (e.g., via backscattering 225) and/or signaling. In an example implementation, both the AIoT device 210 and the NE 102 are located indoors (with the micro cell being part of a group of cells or NEs 102).

FIG. 2B illustrates a second topology 250, where the UE 104, or another node, acts as an intermediate node between the NE 102 and the AIoT device 210. For example, the UE 104 may function as an emitter and/or reader, where the UE 104 sends carrier waves to the AIoT device 210, which excite the AIoT device 210, enabling or causing the AIoT device 210 to performing the backscattering transmissions 225, which are read by the UE 104.

In the second topology 250, the AIoT device 210 directly and bidirectionally communicates with the UE 104 (e.g., which may relay data to the NE 102, serving a macro cell). A communication link 260 between the UE 104 and the AIoT device 210 and/or a link 270 between the UE 104 and the NE 102 may include AIoT data (e.g., via backscattering 225) and/or signaling. In an example implementation, the AIoT device 210 and the UE 104 are both located indoors and the NE 102 is located outdoors (with the macro cell being part of a group of cells or NEs 102).

The AIoT device 210 may communicate with the intermediate node and/or the network (e.g., via the NE 102) using a reduced set of components. For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

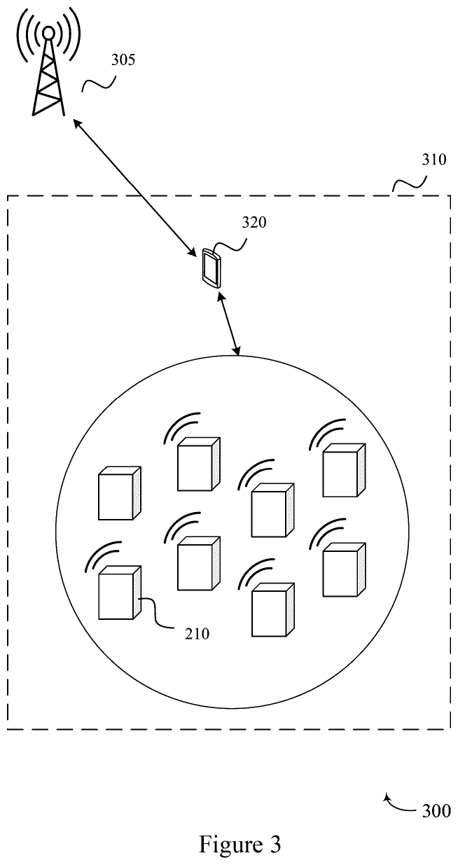

FIG. 3 illustrates an example deployment scenario 300 for a reader device and associated AIoT devices in accordance with aspects of the present disclosure. A location 310, or target area (e.g., a warehouse or other indoor facility), is served by a base station 305 in communication with (e.g., serving) a UE 320, or other RAN node, deployed and/or positioned as a reader device with respect to various AIoT devices 210 (e.g., 100 or more AIoT devices). The UE 320 may be a stationary reader device (e.g., a device fixed or installed to one location within the location 310), a mobile reader device (e.g., a device that moves within the location 310), and so on.

As described herein, a network function initiates AIoT operations with a RAN node, such as the UE 320, by sending a request message that includes an ID filter mask for selecting AIoT devices (e.g., some of the AIoT devices 210) for the AIoT operations. The UE 320, receiving the request message, determines whether the size of the ID filter mask can be accommodated by an R2D message configured to trigger the requested AIoT operations. When the size of the ID filter mask can be accommodated, the UE 320 initiates the R2D message to select the AIoT devices for the requested AIoT operations.

However, when the size of the ID filter mask cannot be accommodated (e.g., the size is too large), the UE 320 may transmit a failure message back to the network function. The failure message may include assistance information that indicates a reason (e.g., cause) for the failure (e.g., size of ID filter mask is too large) and/or a recommended maximum ID filter mask size. For example, the UE 320 may determine, select, or adapt a maximum size of D2R and/or R2D messages based on various factors, including:

When energy status reports for the AIoT devices 210 are available to the UE 320, the UE 320 may adapt the maximum size of the D2R and/or R2D messages based on energy availability at the AIoT devices 210. The messages may have a fixed maximum size, or be variable in size (e.g., based on different energy availabilities at the AIoT devices 210);

When there are no available energy status reports, the UE 320 may proactively reduce the size of the D2R and/or R2D messages during an AIoT procedure (e.g., in a progressive manner). For example, messages in a first inventory round may have a larger size than messages in a subsequent inventory round. In some cases, the message size may be based, at least in part, on a number or ratio of AIoT devices selected for an AIoT operation; and/or other factors.

The network function, based on the failure message, may generate a new ID filter mask having a suitable size, and transmit the new ID filter mask to the UE 320.

As described herein, the technology, in some embodiments, may be implemented as one or more messaging flows between a reader device (e.g., a RAN node, such as the UE 320 or the base station 305) and a network function (e.g., an AIOTF and/or AF).

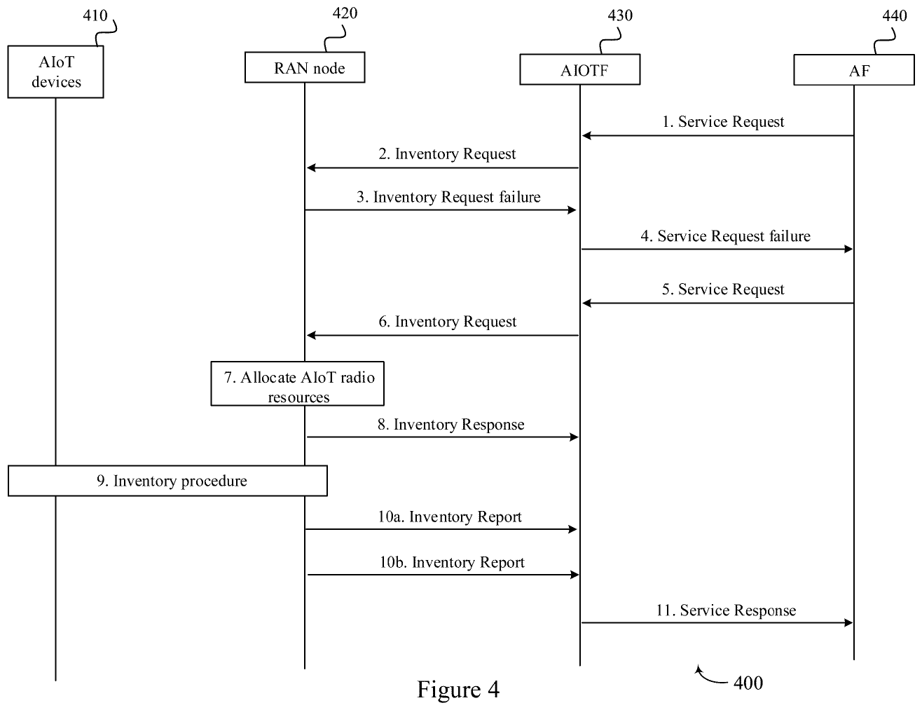

FIG. 4 illustrates a messaging flow 400 for performing an AIoT operation in accordance with aspects of the present disclosure. The messaging flow 400 may implement various aspects of the present disclosure described herein. For example, the messaging flow 400 may include AIoT devices 410, a RAN node 420, an AIOTF 430, and an AF 440, which may be examples of AIoT devices, RAN nodes, AIOTFs and AFs as described herein. In the following description of the messaging flow 400, the operations between the AIoT devices 410, the RAN node 420, the AIOTF 430, and the AF 440 may be performed in different orders or at different times. Some operations may also be omitted, or other operations may be added. Although the AIoT devices 410, the RAN node 420, the AIOTF 430, and the AF 440 are shown performing the operations of the messaging flow 400, some aspects of some operations may also be performed by other entities of the messaging flow 400 or by entities that are not shown in the messaging flow 400, or any combination thereof.

In step 1, the AF 440 sends a service request message to the AIOTF 430. For example, the AF 440 may request an inventory, or a re-inventory of all AIoT devices (e.g., to retrieve device IDs for all of the AIoT devices 410) at a certain location (e.g., the location 310). The AF 440 may generate an ID filter mask to be used for device selection. The service request message may include the following information:

A target service area;

An ID filter mask of size that is encoded by up to 420 bits, as follows: (1) a starting bit for a mask comparison=“100”, (2) a length of the mask=400 bits, and (3) mask value=a bit mask of up to 400 bits;

An AIoT service type set to “inventory’; and

An approximate number of targeted AIoT devices (e.g., the AIoT devices 410) set to N=100.

In step 2, the AIOTF 430 sends an inventory request message to the RAN node 420. For example, the RAN node 420 serves the target service area. The inventory request message contains the information in the service request message.

In step 3, the RAN node 420 sends an inventory failure message to the AIOTF 430. For example, the RAN node 420 determines that the received ID filter mask cannot be accommodated into an R2D message that triggers an AIoT inventory procedure for the AIoT devices 410. The inventory request failure message may include the following information: a failure reason (e.g., cause) set to “insufficient message size,” and/or a recommended (e.g., a maximum) ID filter mask size set to “300 bits.”

In step 4, the AIOTF 430 sends a service request failure message to the AF 440. For example, the AIOTF 430 forwards the failure information received from the RAN node 420 to the AF 440.

In step 5, the AF 440 sends a new service request message to the AIOTF 430. For example, using the failure information, the AF 440 generates a new ID filter mask of size 300 bits that includes the following information: (1) a starting bit for a mask comparison=“150,” (2) a length of the mask=280 bits, and (3) mask value=a bit mask of up to 280 bits. The AF 440 sends the new service request message containing the new ID filter mask.

In step 6, the AIOTF 430 sends an inventory request message to the RAN node 420. The inventory request message includes the new ID filter mask generated by the AF 440.

In step 7, the RAN node 420 allocates AIoT resources. For example, the RAN node 420 determines that the received ID filter mask can be accommodated into an R2D message that triggers the AIoT inventory procedure and allocates the AIoT radio resources for the AIoT inventory procedure.

In step 8, the RAN node 420 sends an inventory response message to the AIOTF 430. For example, the RAN node 420 indicates that the inventory procedure will be initiated with respect to the AIoT devices 410.

In step 9, the RAN node 420 performs the inventory procedure. For example, the RAN node 420 retrieves, over the radio AIoT interface, stored device IDs from the target AIoT devices 410 in the target service area. The RAN node 420 may transmit an R2D message that triggers the AIoT inventory operation for the selected set of AIoT devices (e.g., the N=100 AIoT devices, containing the ID filter mask and other information (e.g., allocated AIoT radio resources to be used between the RAN node 420 and the AIoT devices 410). As described herein, the AIoT devices 410 receive the R2D message from the RAN node 420 and determine whether their unique permanent AIoT device IDs match with the received filter mask. When matched, an AIoT device is selected for the triggered AIoT inventory operation and performs the inventory procedure.

In steps 10a/10b, the RAN node 420 transmits one or more inventory reports to the AIOTF 430. For example, after received inventory results (e.g., stored IDs from D2R messages received from the AIoT devices 410), the RAN node 420 transmits reports that contain the stored IDs to the AIOTF 430.

In step 11, the AIOTF 430 sends a service response message to the AF 440. For example, the AIOTF 430 transmits the inventory result (e.g., the stored IDs) to the AF 440 to complete the inventory procedure initiate requested by the AF 440.

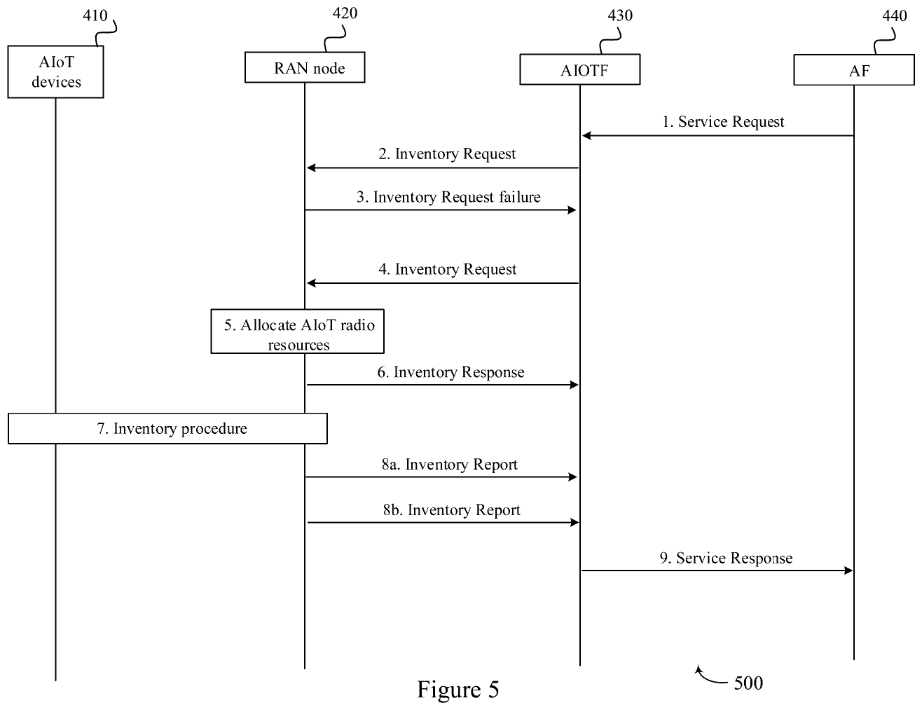

In some embodiments, the AIOTF 430 may generate the new ID filter mask upon receiving a failure response from the RAN node 420. FIG. 5 illustrates another messaging flow 500 for performing an AIoT operation in accordance with aspects of the present disclosure. The messaging flow 500 may implement various aspects of the present disclosure described herein. For example, the messaging flow 500 may include AIoT devices 410, a RAN node 420, an AIOTF 430, and an AF 440, which may be examples of AIoT devices, RAN nodes, AIOTFs and AFs as described herein. In the following description of the messaging flow 500, the operations between the AIoT devices 410, the RAN node 420, the AIOTF 430, and the AF 440 may be performed in different orders or at different times. Some operations may also be omitted, or other operations may be added. Although the AIoT devices 410, the RAN node 420, the AIOTF 430, and the AF 440 are shown performing the operations of the messaging flow 500, some aspects of some operations may also be performed by other entities of the messaging flow 500 or by entities that are not shown in the messaging flow 500, or any combination thereof.

In step 1, the AF 440 sends a service request message to the AIOTF 430. For example, the AF 440 may request an inventory, or a re-inventory of all AIoT devices (e.g., to retrieve device IDs for all of the AIoT devices 410) at a certain location (e.g., the location 310). The AF 440 may generate an ID filter mask to be used for device selection. The service request message may include the following information:

A target service area;

An ID filter mask of size that is encoded by up to 420 bits, as follows: (1) a starting bit for a mask comparison=“100”, (2) a length of the mask=400 bits, and (3) mask value=a bit mask of up to 400 bits;

An AIoT service type set to “inventory’; and

An approximate number of targeted AIoT devices (e.g., the AIoT devices 410) set to N=100.

In step 2, the AIOTF 430 sends an inventory request message to the RAN node 420. For example, the RAN node 420 serves the target service area. The inventory request message contains the information in the service request message.

In step 3, the RAN node 420 sends an inventory failure message to the AIOTF 430. For example, the RAN node 420 determines that the received ID filter mask cannot be accommodated into an R2D message that triggers an AIoT inventory procedure for the AIoT devices 410. The inventory request failure message may include the following information:

Failure reason set to “insufficient message size”; and

Recommended maximum ID filter mask size set to “300 bits.”

In step 4, the AIOTF 430 sends a new inventory request message to the RAN node 420. For example, unlike the messaging flow 400, the AIOTF 430, using the failure information, generates a new ID filter mask (instead of the AF 440). The ID filter mask may have a size of 300 bits that includes the following information: (1) a starting bit for a mask comparison=“150”, (2) a length of the mask=280 bits, and (3) mask value=a bit mask of up to 280 bits. The AIOTF 430 sends the new inventory request message containing the new ID filter mask.

In step 5, the RAN node 420 allocates AIoT resources. For example, the RAN node 420 determines that the received ID filter mask can be accommodated into an R2D message that triggers the AIoT inventory procedure and allocates the AIoT radio resources for the AIoT inventory procedure.

In step 6, the RAN node 420 sends an inventory response message to the AIOTF 430. For example, the RAN node 420 indicates that the inventory procedure will be initiated with respect to the AIoT devices 410.

In step 7, the RAN node 420 performs the inventory procedure. For example, the RAN node 420 retrieves, over the radio AIoT interface, stored device IDs from the target AIoT devices 410 in the target service area. The RAN node 420 may transmit an R2D message that triggers the AIoT inventory operation for the selected set of AIoT devices (e.g., the N=100 AIoT devices, containing the ID filter mask and other information (e.g., allocated AIoT radio resources to be used between the RAN node 420 and the AIoT devices 410). As described herein, the AIoT devices 410 receive the R2D message from the RAN node 420 and determine whether their unique permanent AIoT device IDs match with the received filter mask. When matched, an AIoT device is selected for the triggered AIoT inventory operation and performs the inventory procedure.

In steps 8a/8b, the RAN node 420 transmits one or more inventory reports to the AIOTF 430. For example, after received inventory results (e.g., stored IDs from D2R messages received from the AIoT devices 410), the RAN node 420 transmits reports that contain the stored IDs to the AIOTF 430.

In step 9, the AIOTF 430 sends a service response message to the AF 440. For example, the AIOTF 430 transmits the inventory result (e.g., the stored IDs) to the AF 440 to complete the inventory procedure initiate requested by the AF 440.

Thus, in various embodiments, the RAN node 420 may function to determine whether received ID filter masks are sized appropriately for use within messaging over an AIoT radio interface during requested AIoT operations, among other benefits.

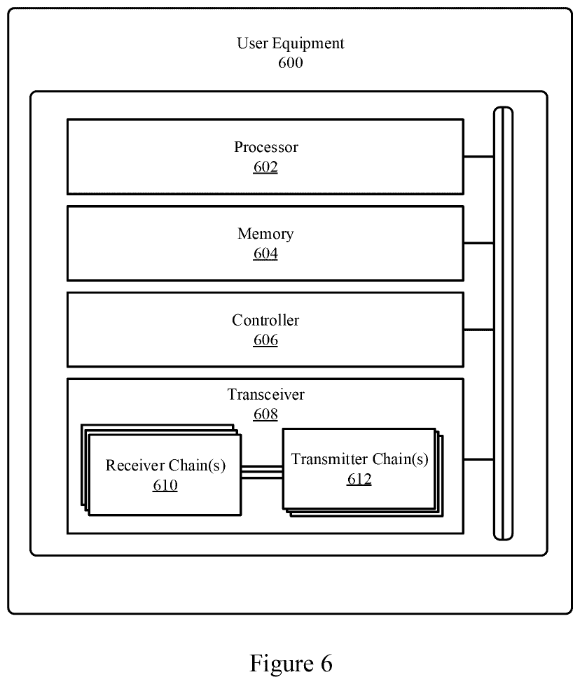

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, from a network function, a first message that includes a request for triggering an AIoT operation and an ID filter mask associated with selecting AIoT devices and transmitting, to the network function, a second message that includes failure information based on the ID filter mask.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

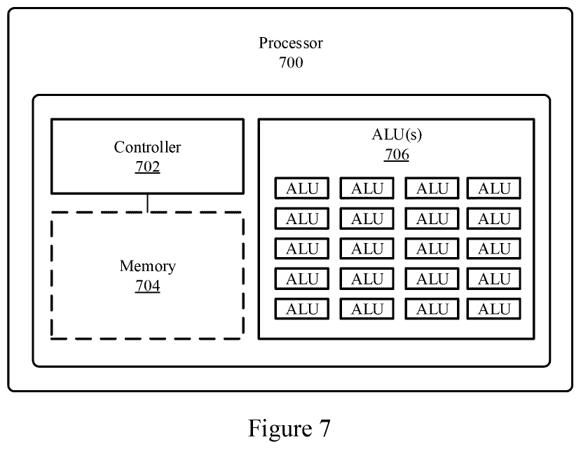

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving, from a network function, a first message that includes a request for triggering an AIoT operation and an ID filter mask associated with selecting AIoT devices and transmitting, to the network function, a second message that includes failure information based on the ID filter mask.

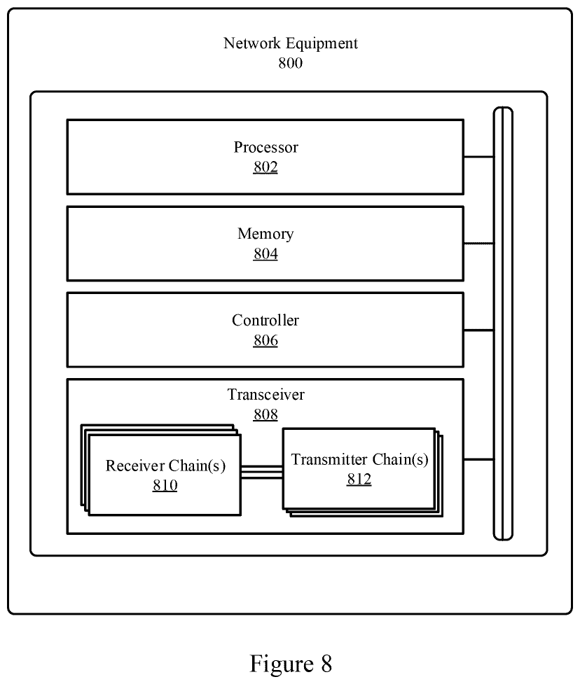

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800, as part of a RAN node, may be configured to support a means for receiving, from a network function, a first message that includes a request for triggering an AIoT operation and an ID filter mask associated with selecting AIoT devices and transmitting, to the network function, a second message that includes failure information based on the ID filter mask.

As another example, the NE 800, as part of a network function, may be configured to support a means for transmitting, to a RAN node, a first message that includes a request for triggering an AIoT operation and an ID filter mask associated with selecting AIoT devices, and receiving, from the RAN node, a second message that includes failure information based on the ID filter mask.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

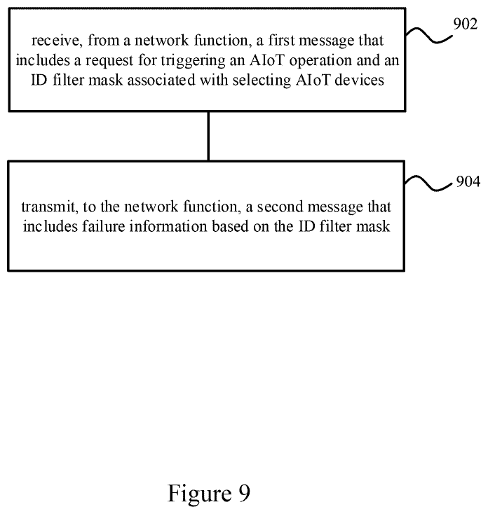

FIG. 9 illustrates a flowchart of a method in accordance with aspects of the present disclosure. The operations of the method may be implemented by a RAN node (e.g., a UE and/or NE operating as a reader device) as described herein. In some implementations, the RAN node may execute a set of instructions to control the function elements of the RAN node to perform the described functions.

At 902, the method may include receiving, from a network function, a first message that includes a request for triggering an AIoT operation and an ID filter mask associated with selecting AIoT devices. The operations of 902 may be performed in accordance with examples as described herein. In some implementations, aspects of the operations of 902 may be performed by a RAN node as described with reference to FIG. 6 or FIG. 8.

At 904, the method may include transmitting, to the network function, a second message that includes failure information based on the ID filter mask. The operations of 904 may be performed in accordance with examples as described herein. In some implementations, aspects of the operations of 904 may be performed by a RAN node as described with reference to FIG. 6 or FIG. 8.

It should be noted that the method described herein describes a possible implementation, and that the operations and the steps may be rearranged or otherwise modified and that other implementations are possible.

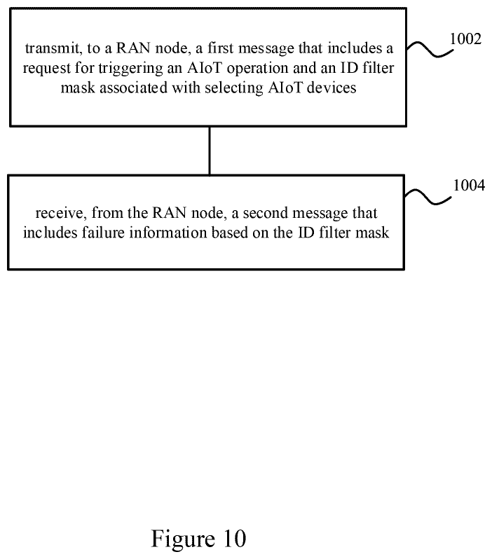

FIG. 10 illustrates a flowchart of a method in accordance with aspects of the present disclosure. The operations of the method may be implemented by an NE (e.g., operating as a network function) as described herein. In some implementations, the NE may execute a set of instructions to control the function elements of the NE to perform the described functions.

At 1002, the method may include transmitting, to a RAN node, a first message that includes a request for triggering an AIoT operation and an ID filter mask associated with selecting AIoT devices. The operations of 1002 may be performed in accordance with examples as described herein. In some implementations, aspects of the operations of 1002 may be performed by an NE as described with reference to FIG. 8.

At 1004, the method may include receiving, from the RAN node, a second message that includes failure information based on the ID filter mask. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio access network (RAN) node for wireless communication, comprising:
at least one memory; and
at least one processor coupled with the at least one memory and configured to cause the RAN node to:
receive, from a network function, a first message that includes a request for triggering an ambient Internet of Things (AIoT) operation and an identifier (ID) filter mask associated with selecting AIoT devices; and
transmit, to the network function, a second message that includes failure information based on the ID filter mask.

2. The RAN node of claim 1, wherein the failure information is based on a size of the ID filter mask being greater than or equal to a threshold size for inclusion within a reader to device (R2D) message.

3. The RAN node of claim 1, wherein the failure information includes:
a reason for a failure to trigger the AIoT operation; and
a requested size of the ID filter mask.

4. The RAN node of claim 1, wherein the at least one processor is further configured to cause the RAN node to:
receive a third message from the network function that includes an ID filter mask having a size that satisfies a threshold size for inclusion within a reader to device (R2D) message; and
transmit the R2D message to trigger the AIoT operation using the ID filter mask received via the third message.

5. The RAN node of claim 1, wherein the RAN node includes a base station, and wherein a coverage area of the base station supports wireless communication for the AIoT devices.

6. The RAN node of claim 1, wherein the RAN node includes a user equipment (UE) configured to operate as a reader device for the AIoT devices.

7. The RAN node of claim 1, wherein the AIoT operation is a command procedure or an inventory procedure associated with the AIoT devices.

8. A network function for wireless communication, comprising:
at least one memory; and
at least one processor coupled with the at least one memory and configured to cause the network function to:
transmit, to a radio access network (RAN) node, a first message that includes a request for triggering an ambient Internet of Things (AIoT) operation and an identifier (ID) filter mask associated with selecting AIoT devices; and
receive, from the RAN node, a second message that includes failure information based on the ID filter mask.

9. The network function of claim 8, wherein the at least one processor is further configured to cause the network function to:
transmit, in response to the failure information, a third message to the RAN node that includes an ID filter mask having a size that satisfies a threshold size for inclusion within a reader to device (R2D) message.

10. The network function of claim 9, wherein the failure information includes:
a reason for a failure to trigger the AIoT operation; and
a requested size of the ID filter mask.

11. The network function of claim 10, wherein the ID filter mask has a size that is based on the size of the ID filter mask.

12. The network function of claim 8, wherein the network function is an application function (AF) of a core network (CN).

13. The network function of claim 8, wherein the network function is an AIoT function (AIOTF) associated with management of the AIoT operation.

14. The network function of claim 8, wherein the ID filter mask includes a mask comparison starting bit, a length of the ID filter mask, and a mask value.

15. A method performed by a radio access network (RAN) node, the method comprising:
receiving, from a network function, a first message that includes a request for triggering an ambient Internet of Things (AIoT) operation and an identifier (ID) filter mask associated with selecting AIoT devices; and
transmitting, to the network function, a second message that includes failure information based on the ID filter mask.

16. The method of claim 15, wherein the failure information is based on a determination that a size of the ID filter mask is outside of a threshold size for inclusion within a reader to device (R2D) message.

17. The method of claim 15, further comprising:
receiving a third message from the network function that includes an ID filter mask having a size that satisfies a threshold size for inclusion within a reader to device (R2D) message; and
transmitting the R2D message to trigger the AIoT operation using the ID filter mask received via the third message.

18. A method performed by a network function, the method comprising:
transmitting, to a radio access network (RAN) node, a first message that includes a request for triggering an ambient Internet of Things (AIoT) operation and an identifier (ID) filter mask associated with selecting AIoT devices; and
receiving, from the RAN node, a second message that includes failure information based on the ID filter mask.

19. The method of claim 18, further comprising:
transmitting, in response to the failure information, a third message to the RAN node that includes an ID filter mask having a size that satisfies a threshold size for inclusion within a reader to device (R2D) message.

20. The method of claim 18, wherein the ID filter mask includes a mask comparison starting bit, a length of the ID filter mask, and a mask value.
